(19) United States
(12) Patent Application Publication
(10) Pub. No.: US 2015/0078809 A1
(43) Pub. Date: Mar. 19, 2015

(54) CABLE TRAY SPLICE AND SUPPORT

(71) Applicant: RICHARD GREGG WINN, BELLEVILLE, IL (US)

(72) Inventor: RICHARD GREGG WINN, BELLEVILLE, IL (US)

(21) Appl. No.: 14/486,928

(22) Filed: Sep. 15, 2014

Related U.S. Application Data
(60) Provisional application No. 61/878,002, filed on Sep. 15, 2013.

(51) Int. Cl. H02G 3/06

(52) U.S. Cl. CPC H02G 3/06
USPC 403/188

(57) ABSTRACT

A wire cable tray splice and support device that can be used splice to wire cable trays together to generate a substantially continuous series of wire cable trays. Various embodiments of the present invention can splice wire cable trays together that the ends of two wire cable trays, or can be used to support a set of wire cable trays from a structure above the wire cable trays, or can be used o mount a series of wire cable trays together along the surface of a vertical wall.

### CROSS REFERENCE TO RELATED APPLICATIONS

This application claims all benefits from U.S. Provisional Application Ser. No. 61/878,002 filed Sep. 15, 2013 which is incorporated by reference as if fully stated herein, and as necessary to support the embodiments and claims herein.

### STATEMENT REGARDING FEDERALLY SPONSORED RESEARCH

Not Applicable.

### BACKGROUND OF THE INVENTION

Electrical system conductors are part of the construction of virtually any building whether the building is residential, business, or even a storage building. In most applications, local construction codes and building techniques dictate the use of metallic conduit mounted to various surfaces of the building. The necessary electrical system conductors are then drawn through the metallic conduit to terminate at the various control points designed within the electrical system.

With the widespread use of a virtually endless variety of electronic equipment and devices, there has also been a constant and steady increase in the use of specialized electrical system conductors in raceways and mechanical areas that do not use normal metallic conduit. Instead, cable trays are first installed within the raceways and mechanical areas. Thereafter, the electrical system conductors and cables are placed into the cable trays where the electrical system conductors remain until they must be serviced or remodeled.

One standard type of cable tray as disclosed in U.S. Patent Application Publication Number 2011-0214776 (WINN) is made from an assembly of wire rods. The circular rods of that device are welded together at various angles to result in what is usually a channel-shaped trellis that can be used as a cable tray. These channel-shaped cable trays are installed within the raceways and mechanical areas such that the two opposing sides of the channel are generally vertical while the web connecting the two opposing sides is mounted to face upward against gravity. The electrical system conductors are placed within the channel-shaped cable tray by simply locating the length of the wires parallel to the longitudinal axis of the channel-shaped cable tray and allowing the electrical system conductors to rest directly upon the wires used to fabricate the transverse members of the channel-shaped tray.

The increased use of optical cables presents a need for a cable tray that does not bend or fracture the delicate optical fibers within the optical cable. Such fractures can be easily caused by high stress point loads on an optical cable when the optical cable is resting on the wire rods of a standard cable tray. Such pressure points can fracture the optical fibers, but the sensitivity of optical fibers is such that even excessive pressure on the optical fibers themselves can affect many of the key performance characteristics of the optical cable such as the optical fiber's transmission signal speed, the operable bandwidth of the optical fiber, and the general performance integrity of the optical cable. In severe cases, these excessive pressures can also affect these same performance characteristics for copper data cables. Thus, there is a need for a cable tray splicing device that acts to generally reduce the point load on certain electrical conductors and that can be easily adapted to provide for quick and efficient splicing of two or more wire cable trays together to generate a run of cable trays.

### SUMMARY OF THE INVENTION

This section provides a general summary of the disclosure, and is not a comprehensive disclosure of its full scope or all of its features.

This invention relates to an apparatus for installing electrical system conductors, and more specifically to a support and splicing system for use in interconnecting two or more wire cable trays together to form a run of cable trays. Various embodiments of the present invention utilize different shaped rods to provide combinations of concentrated strength, better rigidity, and reduction of stress concentration points between the outer surface of the various shaped rods and the electrical system conductors disposed within the cable tray.

Further areas of applicability will become apparent from the description provided herein. The description and specific examples in this summary are intended for purposes of illustration only and are not intended to limit the scope of the present disclosure.

### DESCRIPTION OF THE DRAWINGS

In the accompanying drawings which form part of the specification:

FIG. 1 is a perspective view showing one embodiment of the present invention as used to splice two cable trays in one application;

FIG. 2 is a perspective view of one embodiment of the present invention showing the general shape of that embodiment;

FIG. 3 is a vertical cross section of one embodiment of the present invention showing one method of interconnecting two cable trays together by use of this embodiment;

FIG. 3A is a vertical cross section of one embodiment of the present invention showing a placement if the longitudinal wires into openings in the first vertical portions of this embodiment;

FIG. 3B is a vertical cross section of one embodiment of the present invention showing a placement if the longitudinal wires into openings of the recurved portions of this embodiment;

FIG. 4 is a perspective view of an alternative embodiment of the present invention that is mounted to a wall installation where two cable trays are spliced together;

FIG. 5 is a perspective view of an alternative embodiment of the present invention that is mounted to a wall installation to support a cable tray at a point other than the end of the cable tray;

FIG. 6 is a perspective view of an alternative embodiment of the present invention that is mounted to a ceiling installation and shows the general shape of this embodiment;

FIG. 7 is a perspective view of an alternative embodiment of the present invention that is suspended in a ceiling installation where two cable trays are spliced together;

FIG. 8 is a perspective view of an alternative embodiment of the present invention that is suspended in a ceiling installation to support a cable tray at a point other than the end of the cable tray; and,

FIG. 9 is a perspective view of an alternative embodiment of the present invention that is used in a suspended ceiling installation and shows the general shape of this embodiment.

Corresponding reference numerals indicate corresponding steps or parts throughout the several figures of the drawings.

While one embodiment of the present invention is illustrated in the above referenced drawings and in the following description, it is understood that the embodiment shown is merely one example of a single preferred embodiment offered for the purpose of illustration only and that various changes in construction may be resorted to in the course of manufacture in order that the present invention may be utilized to the best advantage according to circumstances which may arise, without in any way departing from the spirit and intention of the present invention, which is to be limited only in accordance with the claims contained herein.

### DETAILED DESCRIPTION OF A PREFERRED EMBODIMENT OF THE INVENTION

In the following description, numerous specific details are set forth such as examples of specific components, devices, methods, in order to provide a thorough understanding of embodiments of the present disclosure. It will be apparent to a person of ordinary skill in the art that these specific details need not be employed, and should not be construed to limit the scope of the disclosure. In the development of any actual implementation, numerous implementation-specific decisions must be made to achieve the developer's specific goals, such as compliance with system-related and business-related constraints. Such a development effort might be complex and time consuming, but is nevertheless a routine undertaking of design, fabrication, and manufacture for those of ordinary skill.

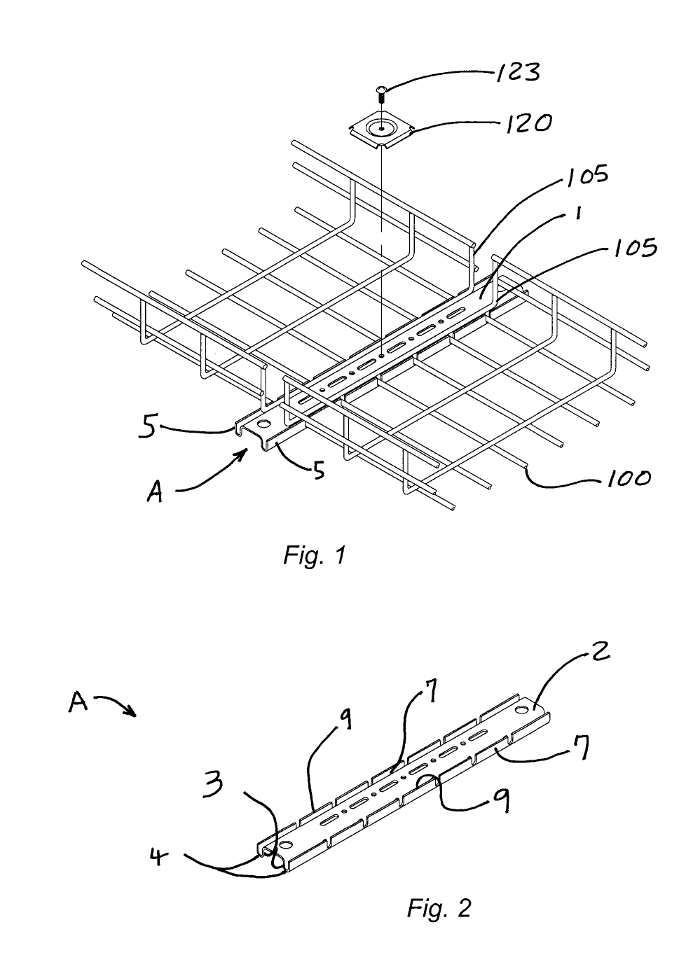

A set of preferred embodiments of the CABLE TRAY SPLICE AND SUPPORT A of the present invention are illustrated in FIG. 1 through FIG. 9. One example of the physical configuration of a preferred embodiment of the present invention is shown in FIG. 1 and FIG. 2 where the CABLE TRAY SPLICE AND SUPPORT A comprises a primary element 1 having a generally channel-shaped cross section that includes a first horizontal portion 2 generally perpendicular to two first vertical portions 3 wherein the horizontal portion and the two first vertical portions combine to form a substantially channel-shaped element. A recurved portion 5 is located at the edges of each of the two first vertical portions 3 and each recurved portion includes a second horizontal portion 4 generally perpendicular to its related first vertical portion and a second vertical portion 7 that is generally perpendicular to the second horizontal portion 4 and is generally parallel to the two first vertical portions 3. It is understood that in alternative embodiments, the second horizontal portion 4 is replaced with a fully radiused portion connecting the first vertical portions 3 to the second vertical portions 7.

In the present embodiment, edges 9 the second vertical portions 7 are not coplanar with the horizontal portion 2 and are instead lower than the upper surface of the horizontal portion. Those of skill in the art, however, will understand that in other embodiments, the edges 9 may be coplanar with the upper surface or higher than the upper surface of the horizontal portion 2 and still remain within the intended scope of the present invention. The horizontal portion 2 includes a series of slots, circular openings, and square openings 8 disposed generally along the longitudinal axis of CABLE TRAY SPLICE AND SUPPORT A for use with fasteners, braces, and other components to assemble a series of CABLE TRAY SPLICE AND SUPPORT A as needed for a particular application, some of which are described herein. It is understood that the slots, circular openings, and square openings 8 shown in FIGS. 1 and 2 can be used in any location or combination as needed to allow the present invention to be located is needed in any specific applications.

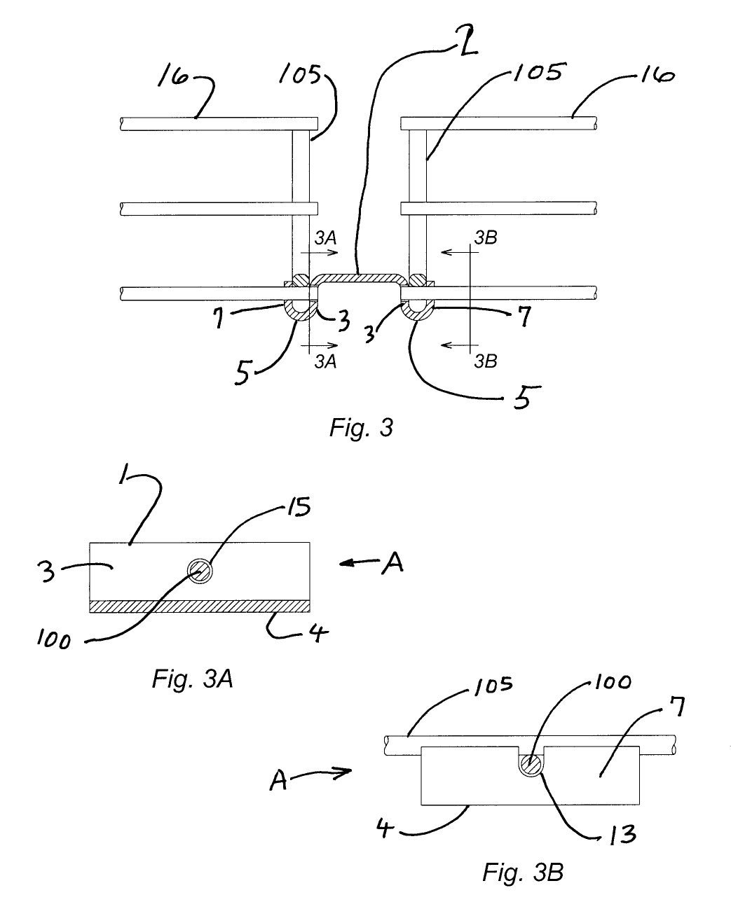

FIG. 3, 3A, and 3B disclose one embodiment of the present invention. Generally, the present embodiment comprises a length of material having a cross section in the general shape of an inverted channel having recurved flanges on the edges of each of the two first vertical portions 3. A plurality of wire openings 15 about 0.62 inch in diameter are disposed in the two second vertical portions 7 wherein the openings are sized and configured to match the tips of longitudinal wire components 100 that form wire cable trays 16. Additionally, a plurality of open-ended slots 13 are disposed in the recurved flanges of the cross section having a size of about 0.375 inch in width and about 0.25 inch in depth, wherein the plurality of open-ended slots is aligned with the plurality of wire openings.

More specifically, FIG. 1 shows one typical application of the current invention to splice two wire cable trays 16 together. It is understood that the wire cable tray 16 includes a set of longitudinal wire components 100. In this embodiment, each of the set of longitudinal wire components extends beyond the last transverse member 105 as shown in FIG. 3. It is appreciated that the spacing, size, and locations of the ends of the longitudinal wire components 100 match the spacing, size, and locations of the plurality of wire openings 15 disposed in the two first vertical portions 3 and the plurality of open-ended slots 13 that are disposed in the second vertical portions 7 of the cross section wherein the plurality of open-ended slots are substantially aligned with the plurality of wire openings.

Referring now to FIG. 3, 3A, and 3B it is understood that in this embodiment, the tips of the wire cable tray longitudinal components 100 are inserted into the matching wire openings 15 while lifting the last cross member 105 of the cable tray 16 over the recurved portion 5 of the CABLE TRAY SPLICE AND SUPPORT A. When the tips of the wire cable tray longitudinal components 100 are inserted into the wire openings 15, the CABLE TRAY SPLICE AND SUPPORT A is rotated a sufficient amount to engage the shape of the last cross member 105 between the recurved portions 5 and the first vertical portions 3. When the same process is repeated on the other side of the CABLE TRAY SPLICE AND SUPPORT, the result is a first wire cable tray 16 installed into one side of the CABLE TRAY SPLICE AND SUPPORT A while a second wire cable tray 16 is installed into the other side of the CABLE TRAY SPLICE AND SUPPORT A.

The CABLE TRAY SPLICE AND SUPPORT A can also be placed beneath a cable tray 16 at a point other than where two cable trays are spliced together. For example, referring to FIG. 5, the present embodiment of the CABLE TRAY SPLICE AND SUPPORT A can be installed beneath a cable tray to support that cable between the splice points.

In many applications the general friction between the components being spliced together can be sufficient to retain the wire cable trays 16 in position on the CABLE TRAY SPLICE AND SUPPORT A. In alternative embodiments, auxiliary components can be used to enhance the ability of the assembled components to remain assembled. For example, FIG. 1 discloses the use of a washer 120 that has been fastened to the CABLE TRAY SPLICE AND SUPPORT A with a fastener 123. The shape of the washer assists in retaining the elements of the two wire cable trays 16 onto the CABLE TRAY SPLICE AND SUPPORT A.

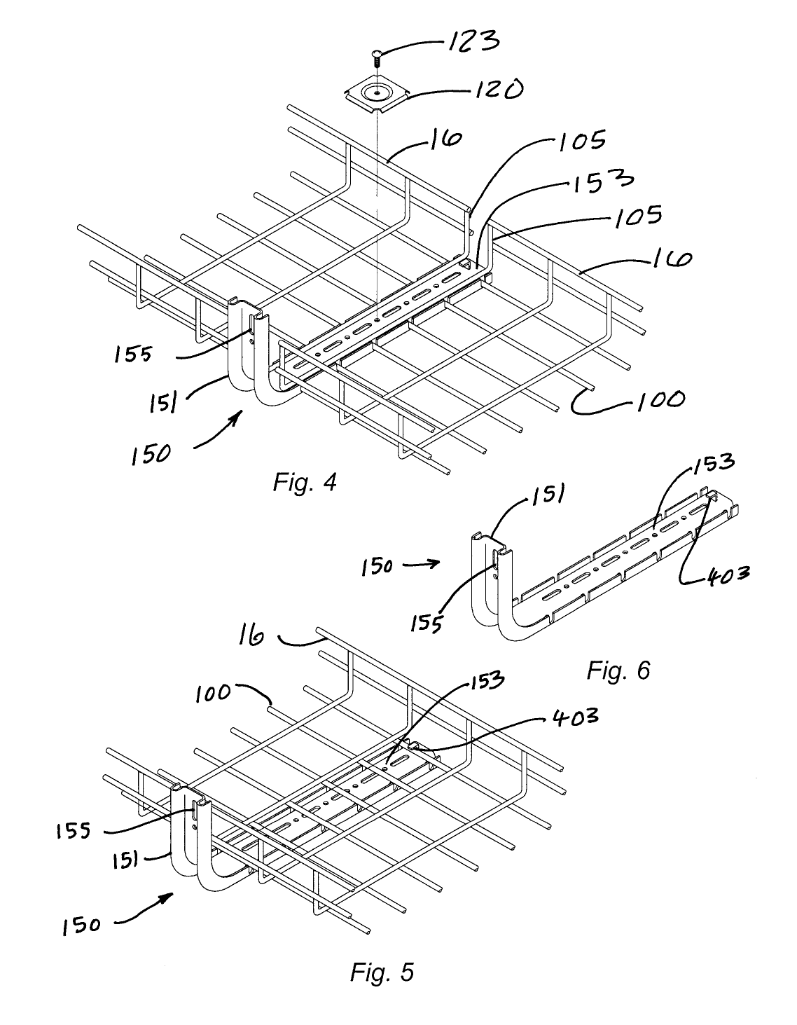

FIGS. 4, 5, and 6 disclose an alternative embodiment of the CABLE TRAY SPLICE AND SUPPORT A wherein the CABLE TRAY SPLICE AND SUPPORT is generally formed into a bracket that is substantially L-shaped and that can be used to support wire cable trays from a vertical wall surface. More specifically, the CABLE TRAY SPLICE AND SUPPORT A in this embodiment includes a vertical element 151 and a horizontal element 153. The vertical element 151 includes at least one mounting opening for attachment of the CABLE TRAY SPLICE AND SUPPORT A to a wall.

It is understood that the cross section of the vertical element 151 and the horizontal element 153 is generally the same as the cross section of the CABLE TRAY SPLICE AND SUPPORT A as shown in FIG. 1, 2, 3, 3A, and 3B. It is also understood that the present embodiment generally includes the plurality of wire openings 15 disposed in the two first vertical portions and the plurality of open-ended slots 13 disposed in the second vertical portions 7 wherein the plurality of open-ended slots are substantially aligned with the plurality of wire openings. Thus, as shown in FIGS. 4, 5, and 6 for the current CABLE TRAY SPLICE AND SUPPORT A embodiment with the horizontal element 153 may still be utilized to splice wire cable trays together as disclosed for the previous embodiments as shown in FIG. 3, 3A, and 3B. Additionally, this embodiment can also include the a series of slots, circular openings, and square openings 8 for use in mounting, installing, and connecting CABLE TRAY SPLICE AND SUPPORT A. Similarly, alternative devices such as washers 120 and fasteners 123 may be used to enhance the retention of the assembled components, and integrated clips as shown in FIG. 8 may also be used to couple the CABLE TRAY SPLICE AND SUPPORT A and wire cable tray together.

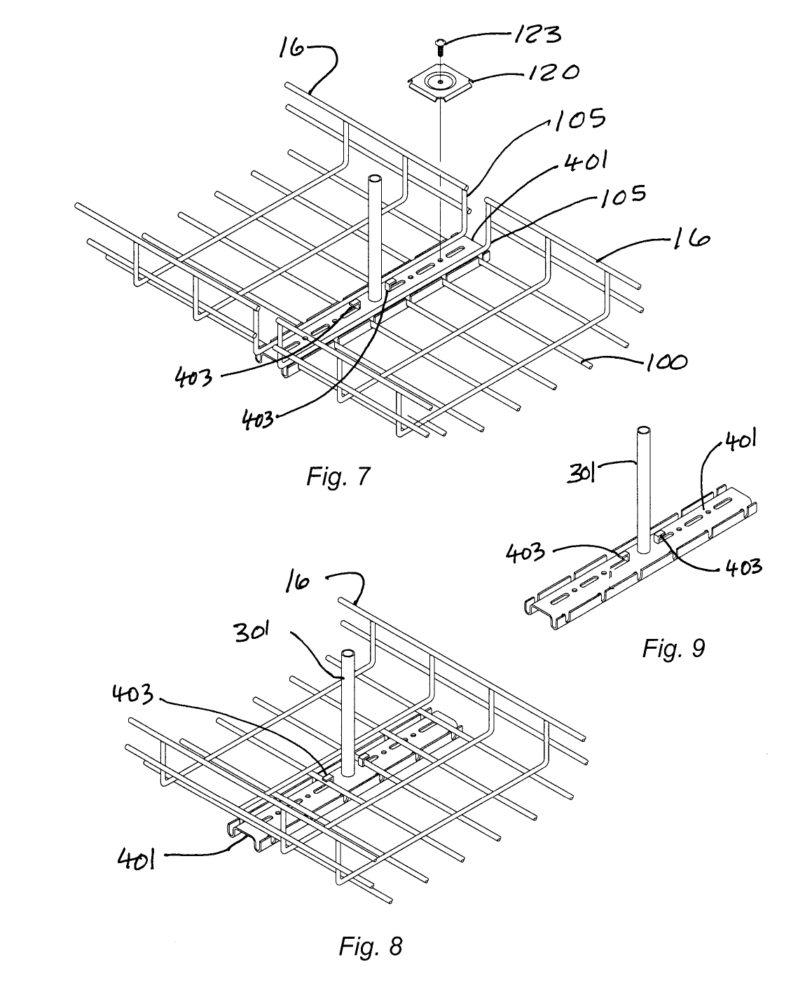

In yet another alternative embodiment of the present invention, a vertical support 301 can be incorporated into the CABLE TRAY SPLICE AND SUPPORT A to allow the CABLE TRAY SPLICE AND SUPPORT to be hung from components disposed above the wire cable trays. For example, FIGS. 7, 8, and 9 describe the CABLE TRAY SPLICE AND SUPPORT A onto which a vertical support 301 has been mounted to a splice element 401. As in the previous embodiments, any of a number of mounting openings and devices may be used to install washers 120 and fasteners 123 for assembly of the CABLE TRAY SPLICE AND SUPPORT A to the wire cable trays. Additionally, this embodiment also can include the a series of slots, circular openings, and square openings 8 for use in mounting, installing, and connecting CABLE TRAY SPLICE AND SUPPORT A. It is also understood that the cross sections of the vertical element 151 and the horizontal element 153 are generally the same as the cross section of the CABLE TRAY SPLICE AND SUPPORT A as shown in FIG. 1, 2, 3, 3A, and 3B. It is also understood that the present embodiment includes the plurality of wire openings 15 disposed in the two first vertical portions and the plurality of open-ended slots 13 disposed in the second vertical portions 7 wherein the plurality of open-ended slots are substantially aligned with the plurality of wire openings.

Referring now to FIG. 8 and FIG. 9 it will be appreciated that the use and location of a plurality of clips 403 allow the CABLE TRAY SPLICE AND SUPPORT A to be quickly installed onto a wire cable tray 16 to support the wire cable tray at locations other than at the splice point between two wire cable trays. The clips 403 are located near the vertical support 301 of the CABLE TRAY SPLICE AND SUPPORT A and the tips of the clips are pointed away from the center of the vertical support. This location allows the CABLE TRAY SPLICE AND SUPPORT A to be rotated such that the longitudinal axis of the CABLE TRAY SPLICE AND SUPPORT A is parallel with the longitudinal wires 100 of the cable tray 16, allows the vertical support 301 to be inserted upward through the wire components of the wire cable tray 16, and then allows the 90 degree rotation of the CABLE TRAY SPLICE AND SUPPORT A to engage the clips 403 with the longitudinal components 100 of the wire cable tray 16. It is understood that while certain preferred embodiments of the CABLE TRAY SPLICE AND SUPPORT A show the clips 403 as being integrated with the material used to make the CABLE TRAY SPLICE AND SUPPORT A, the clips may alternatively be operatively disposed at the CABLE TRAY SPLICE AND SUPPORT and still remain within the intended scope of the present invention.

In most of the preferred embodiments of the present invention, the CABLE TRAY SPLICE AND SUPPORT A is made from a commercial quality mill galvanized steel per ASTM A563 & A924 W/G-90 coating and having a yield strength of about 33 ksi and having a thickness of 14 ga. that is about 0.1084 inch. Additionally, most of the described embodiments are alto be commercial hot pickled & oiled steel per ASTM A569. In certain preferred embodiments, the overall height of the CABLE TRAY SPLICE AND SUPPORT A will be between 0.5 and about 0.8 inches, and preferably about 0.62 inches, while the overall width of the CABLE TRAY SPLICE AND SUPPORT A will be between about 1.5 and about 2.0 inch, and preferably about 1.63 inch. It will be appreciated by those of skill in the art, however, that other materials, coatings, treatments, and sizes may also be used as needed to fit a particular application of an embodiment of the present invention and still remain within the intended scope of the claims herein as long as the general shape and method of splicing remains substantially as described and disclosed herein.

The foregoing description of the embodiments of the present invention has been provided for purposes of illustration and description. As various changes could be made in the above constructions without departing from the scope of the invention, it is intended that all matter contained in the above descriptions or shown in the accompanying drawings shall be interpreted as illustrative and not in a limiting sense.

It will also be seen in the above disclosure that several of the intended purposes of the invention are achieved, and other advantageous results obtained. Additionally, in the preceding description, numerous specific details are set forth such as examples of specific components, devices, methods, in order to provide a thorough understanding of embodiments of the present disclosure. It will be apparent to a person of ordinary skill in the art that these specific details need not be employed, and should not be construed to limit the scope of the disclosure.

The disclosure herein is also not intended to be exhaustive or to limit the invention to the precise forms disclosed. Individual elements or features of a particular embodiment are generally not limited to that particular embodiment, but, where applicable, are interchangeable and can be used in a selected embodiment, even if not specifically shown or described.

In the development of any actual implementation, numerous implementation-specific decisions must be made to achieve the developer's specific goals, such as compliance with system-related and business-related constraints. Such a development effort might be complex and time consuming, but is nevertheless a routine undertaking of design, fabrication and manufacture for those of ordinary skill. The scope of the invention should be determined by any appended claims and their legal equivalents, rather than by the examples given.

Terms such as “proximate,” “distal,” “upper,” “lower,” “inner,” “outer,” “inwardly,” “outwardly,” “exterior,” “interior,” “vertical,” or “horizontal” and the like when used herein refer to positions of or between the respective elements as they are shown in the accompanying drawings, and the disclosure is not necessarily limited to such positions. Terms such as “first,” “second,” and other numerical terms when used herein do not imply a sequence or order unless clearly indicated by the context.

When introducing elements or features and the exemplary embodiments, the articles “a,” “an,” “the” and “said” are intended to mean that there are one or more of such elements or features. The terms “comprising,” “including,” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

It will be understood that when an element is referred to as being “connected,” “coupled,” “engaged,” or “engageable to and/or with another element, it can be directly connected, coupled, engaged, engageable to and/or with the other element or intervening elements may be present. In contrast, when an element is referred to as being “directly connected,” “directly coupled,” “directly engaged,” or “directly engageable” to another element, there are no intervening elements present. Other words used to describe the relationship between elements should be interpreted in a like fashion (e.g., “between” versus “directly between,” “adjacent” versus “directly adjacent,” etc.).

What is claimed is:

1. A wire cable tray splice and support device comprising:
a primary element having a cross section in the general shape of a channel having recurved portions on the edges of each of the two first vertical portions of the channel;
a plurality of wire openings disposed in the two first vertical portions of the primary element wherein the openings are sized and configured to match the tips of a set of longitudinal wires of a wire cable tray; and
a plurality of open-ended slots disposed in the recurved portions of the cross section of the primary element wherein the plurality of open-ended slots are substantially aligned with the plurality of wire openings in the first vertical portions.

2. The wire cable tray splice and support device of claim 1 wherein the primary element includes a first horizontal portion generally perpendicular to the first vertical portions wherein the first horizontal portion and the first vertical portions combine to form a substantially channel-shaped element, wherein a recurved portion is located at the edges of each of the first vertical portions and each recurved portion includes a second horizontal portion generally perpendicular to its related first vertical portion and a second vertical portion that is generally perpendicular to the second horizontal portion and is generally parallel to the first vertical portions.

3. The wire cable tray splice and support device of claim 2 wherein the edges of the second vertical portions are not coplanar with the first horizontal portion

4. The wire cable tray splice and support device of claim 2 wherein the edges the second vertical portions are coplanar with the first horizontal portion.

5. The wire cable tray splice and support device of claim 3 wherein plurality of wire openings have a diameter of about 0.62 inch, wherein the open-ended slots are about 0.375 inch in width and about 0.25 inch in depth and wherein the plurality of wire openings and the open-ended slots are substantially axially aligned.

6. The wire cable tray splice and support device of claim 5 wherein the first horizontal portion includes a series of slots, circular openings, and square openings disposed generally along a longitudinal axis of the primary element.

7. The wire cable tray splice and support device of claim 6 further comprising at least one washer and one fastener installed over at least a portion of a transverse element of a cable tray and into the first horizontal portion of the primary element.

8. The wire cable tray splice and support device of claim 6 wherein the primary element is generally L-shaped having a vertical element and a horizontal element substantially perpendicular to the vertical element and wherein the vertical element includes at least one mounting opening.

9. The wire cable tray splice and support device of claim 8 further comprising at least one washer and one fastener installed over at least a portion of a transverse element of a cable tray and into the first horizontal portion of the primary element.

10. The wire cable tray splice and support device of claim 6 further comprising a vertical support operatively connected to the first horizontal portion of the primary element.

11. The wire cable tray splice and support device of claim 9 further comprising at least one washer and one fastener installed over at least a portion of a transverse element of a cable tray and into the first horizontal portion of the primary element.
